(19) United States
(12) Patent Application Publication
(10) Pub. No.: US 2013/0261987 A1
(43) Pub. Date: Oct. 3, 2013

(54) SYSTEMS AND METHODS OF IDENTIFYING TYPES OF FAULTS

(71) Applicants: John Wesley Grant, Gardnerville, NV (US); Charles Terrance Hatch, Gardnerville, NV (US)

(72) Inventors: John Wesley Grant, Gardnerville, NV (US); Charles Terrance Hatch, Gardnerville, NV (US)

(21) Appl. No.: 13/431,110

(22) Filed: Mar. 27, 2012

(51) Int. Cl. G06F 19/00

(52) U.S. Cl. 702/39

(57) ABSTRACT

A computing device includes a communication interface for receiving a plurality of signals from a first probe positioned on a first observation plane of a machine component and a second probe that is positioned on a second observation plane of the machine component, wherein the plurality of signals are representative of data from the machine component. A processor coupled to the communication interface is programmed to combine the signals received from the first and second probes to generate a plurality of displacement responses that correspond to a plurality of frequencies of a speed of the machine component. The processor is also programmed to transform the signals to eliminate a plurality of split resonance effects. The processor may also generate data representative of an output of the data received from the signals to identify a type of at least one fault within the machine component.

### BACKGROUND OF THE INVENTION

The field of the invention relates generally to systems that include machines and, more particularly, to a computing device that enables identifying types of faults, such as shaft cracks, within machine components.

At least some known systems, such as power systems, include machines, such as turbines. The machines include components, such as bearings, gears, and/or rotating shafts. The components may wear or fatigue over time resulting in damage or faults, such as a crack within the component and/or a misalignment of the component. Continued operation of machines having damaged components may cause damage to other components or may lead to a premature failure of the component.

To detect damage within a machine, the operation of at least some known machines is maintained with a monitoring system. For example, at least some known monitoring systems use sensors to measure vibration characteristics of at least some components of the machine. Displacement, proximity, and/or vibration measurements can be performed using eddy current sensors, magnetic pickup sensors, microwave sensors, and/or capacitive sensors. The data detected by these sensors are analyzed by the monitoring system and then transmitted to a display device. An output of the analysis may be presented to a user to enable a user to identify any damage, such as shaft cracks, within the machine or component. The data may include measurements and/or various variables that are summed together and/or collated to determine if there is damage.

However, such monitoring systems are unable to distinguish the types of damage that are detected. As a result, a user may be required to manually sift through large amounts of data to ascertain whether the damage detected is actually a crack within the component, as opposed to a different type of damage. Shaft cracks, in particular, are considered one of the most difficult faults to diagnose accurately and to distinguish from other types of faults. For example, for a rotor shaft, the data representative of a shaft crack are shared with many other malfunctions of the shaft, and therefore additional data and/or testing is required to ascertain the presence of the shaft crack. Such methodology may be time-consuming and tedious.

### BRIEF DESCRIPTION OF THE INVENTION

In one embodiment, a computing device is provided. The computing device includes a communication interface configured to receive a plurality of signals from two probes that are each positioned on an observation plane of a machine component, wherein the plurality of signals are representative of data from the machine component. A processor is coupled to the communication interface and programmed to combine the signals received from the first probe and the second probe to generate a plurality of displacement responses that correspond to a plurality of frequencies of a speed of the machine component. The processor is also programmed to transform the plurality of signals received from each of the first probe and the second probe to eliminate a plurality of split resonance effects. The processor may also generate data representative of a graphical output of the data received from the signals to identify a type of at least one fault within the machine component.

In another embodiment, a system is provided. The system includes at least one machine that includes a component and a monitoring system that includes two probes that are each positioned on an observation plane of the component, wherein the plurality of signals are representative of data from the component. A computing device is coupled to the monitoring system, the computing device includes a communication interface that is configured to receive a plurality of signals from the first probe and the second probe, wherein the plurality of signals are representative of data from the component. A processor is coupled to the communication interface and programmed to combine the plurality of signals received from the first probe and the second probe to generate a plurality of displacement responses that correspond to a plurality of frequencies of a speed of the component. The processor is also programmed to transform the plurality of signals received from each of the first probe and the second probe to eliminate a plurality of split resonance effects. Processor may also generate data representative of a graphical output of the data received from the plurality of signals to identify a type of at least one fault within the component.

In yet another embodiment, a method for identifying a type of at least one fault within a machine component is provided. A plurality of signals are received, via a communication interface, from two probes that are each positioned on an observation plane of a machine, wherein the plurality of signals are representative of data from the machine component. The plurality of signals received from the first probe and the second probe are combined, via a processor, to generate a plurality of displacement responses that correspond to a plurality of frequencies of a speed of the machine component. The plurality of signals received from each of the first probe and the second probe are transformed, via the processor, to eliminate a plurality of split resonance effects. Data representative of a graphical output of the data received from the plurality of signals is generated, via the processor, to identify a type of at least one fault within the machine component.

### BRIEF DESCRIPTION OF THE DRAWINGS

FIG. 1 is a block diagram of an exemplary system; and

FIG. 2 is a block diagram of an exemplary computing device that may be used with the system shown in FIG. 1.

### DETAILED DESCRIPTION OF THE INVENTION

The exemplary systems and methods described herein enable a user to readily identify a type of damage within a machine component, such as a crack within a rotor shaft of a turbine. More specifically, the embodiments described herein provide a computing device. The computing device includes a communication interface configured to receive a plurality of signals from two probes that are each positioned on different observation planes of a machine component, wherein the plurality of signals are representative of data from the machine component. A processor is coupled to the communication interface. The processor is programmed to combine the signals received from the first probe and the second probe and the processor generates a plurality of displacement responses that correspond to a plurality of frequencies of a speed of the machine component. The processor is also programmed to transform the plurality of signals received from each of the first probe and the second probe to eliminate a plurality of split resonance effects. The processor may also generate data representative of a graphical output of the data received from the signals to identify a type of at least one fault within the machine component. The processor is also programmed to calculate a peak amplitude frequency and/or a peak amplitude value for the peak. The processor is further programmed to identify a change in the peak amplitude frequency and/or a change in the peak amplitude value to identify a type of at least one fault within the machine component. For example, a decrease in the peak amplitude frequency is representative of a crack within the machine component and an increased and/or a constant peak amplitude frequency is representative of a different type of damage, such as a misalignment, or rub, of the machine component. Accordingly, not only can damage be detected within the component, but a user can readily identify whether the damage detected is a crack, such as a shaft crack, or a different type of damage.

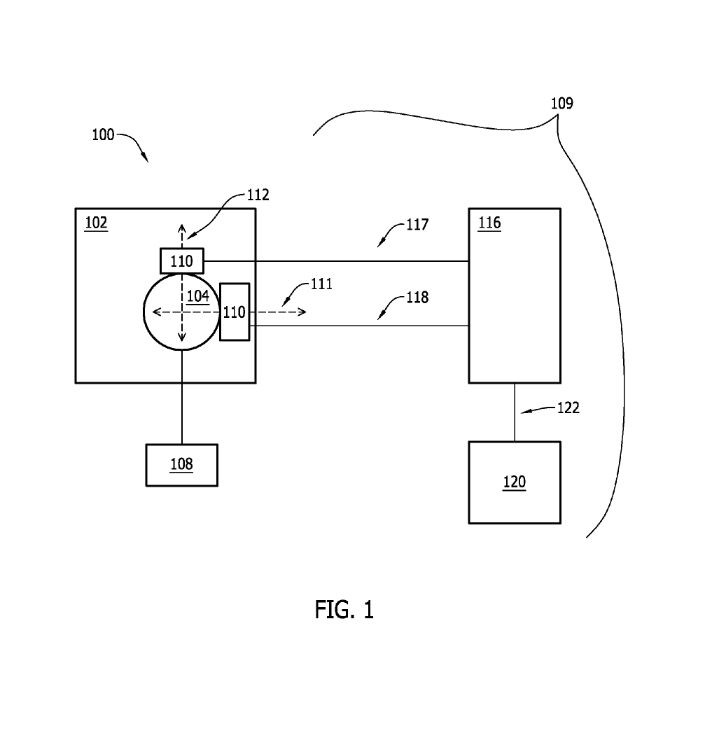

FIG. 1 illustrates a system 100 that includes at least one machine 102. More specifically, system 100, in the exemplary embodiment, is a power system 100. While the exemplary embodiment illustrates a power system, the present disclosure is not limited to power systems and may be used in or with any other type of system. In the exemplary embodiment, machine 102 is a variable speed machine, such as a wind turbine, a hydroelectric steam turbine, and/or any other machine that operates with a variable speed. Alternatively, machine 102 may be a synchronous fixed speed machine. Machine 102 includes at least one machine component 104. In the exemplary embodiment, component 104 is a drive shaft and is coupled to a load 108, such as a generator. It should be noted that, as used herein, the term “couple” is not limited to a direct communicative, mechanical, magnetic, and/or an electrical connection between components, but may also include an indirect communicative, mechanical, magnetic, and/or electrical connection between multiple components.

In the exemplary embodiment, component 104 is at least partially supported by one or more bearings (not shown) housed within machine 102 and/or within load 108. Alternatively or additionally, the bearings may be housed within a separate support structure (not shown), such as a gearbox, or any other structure that enables power system 100 to function as described herein.

Power system 100 also includes a monitoring system 109 that includes at least one sensor or probe 110 coupled to component 104. More specifically, in the exemplary embodiment, power system 100 includes two probes 110 that are mounted to directly sense, detect, or monitor component 104 such that one probe 110 is located on an x observation plane 111 and the other probe 110 is located on a y observation plane 112 at some angular difference from the x probe, but usually orthogonal. Each x observation plane 111 and y observation plane 112 can be rotated to any angular orientation. More specifically, in the exemplary embodiment, each probe 110 is an eddy current displacement probe that measures various parameters related to component 104. For example, each probe 110 may measure and/or monitor a displacement (not shown) between component 104 and each probe 110 in order to detect damage, such as a crack within component 104 and/or a misalignment of component 104. Each probe 110 may also measure and/or monitor a speed of component 104. For example, since component 104 is a shaft, each probe 110 measures the rotational speed of component 104 in revolutions per minute. Alternatively, each probe 110 may be any other type of probe, sensor, or transducer that is able to detect damage within component 104 by measuring and/or monitoring any other parameters of component 104, and that enables system 100 to function as described herein. This timing of this displacement may be measured relative to a third probe 110 that is used to generate a once per rotation timing signal.

In the exemplary embodiment, monitoring system 109 also includes a diagnostic system 116 that is coupled to probes 110. Diagnostic system 116 processes and/or analyzes one or more signals generated by probes 110. As used herein, the term “process” refers to performing an operation on, adjusting, filtering, buffering, and/or altering at least one characteristic of a signal. In the exemplary embodiment, probes are coupled to diagnostic system 116 via a data conduit 117 or a data conduit 118. Alternatively, probes 110 may be wirelessly coupled to diagnostic system 116. In the exemplary embodiment, data conduit 117 and data conduit 118 are each fabricated from a metallic wire. Alternatively, conduits 117 and 118 may be fabricated from any other substance or compound that enables system 100 to function as described herein. In the exemplary embodiment, each conduit 117 and 118 is an electrical conductor and enables the connection between diagnostic system 116 and probes 110. Alternatively, other connections may be available between diagnostic system 116 and probes 110, including a low-level serial data connection, such as Recommended Standard (RS) 232 or RS-485, a high-level serial data connection, such as Universal Serial Bus (USB) or Institute of Electrical and Electronics Engineers (IEEE®) 1394, a parallel data connection, such as IEEE® 1284 or IEEE® 488, a short-range wireless communication channel such as BLUETOOTH®, and/or a private (e.g., inaccessible outside power generation system 100) network connection, whether wired or wireless. IEEE is a registered trademark of the Institute of Electrical and Electronics Engineers, Inc., of New York, N.Y. BLUETOOTH is a registered trademark of Bluetooth SIG, Inc. of Kirkland, Wash.

A computing device 120 is coupled to diagnostic system 116 via a data conduit 122. Alternatively, computing device 120 may be wirelessly coupled to diagnostic system 116. In the exemplary embodiment, data conduit 122 is fabricated from a metallic wire. Alternatively, conduit 122 may be fabricated from any other substance or compound that enables system 100 to function as described herein. In the exemplary embodiment, conduit 122 is an electrical conductor and enables the connection between computing device 120 and diagnostic system 116. Alternatively, other connections may be available between computing device 120 and diagnostic system 116, including a low-level serial data connection, such as Recommended Standard (RS) 232 or RS-485, a high-level serial data connection, such as Universal Serial Bus (USB) or Institute of Electrical and Electronics Engineers (IEEE®) 1394, a parallel data connection, such as IEEE® 1284 or IEEE® 488, a short-range wireless communication channel such as BLUETOOTH®, and/or a private (e.g., inaccessible outside power generation system 100) network connection, whether wired or wireless.

In the exemplary embodiment, as explained in more detail below, computing device 120 is configured to process and/or analyze data received from diagnostic system 116 and present an output of the data to a user, such as an operator of system 100. In the exemplary embodiment, computing device 120 is configured to present historical and/or real-time data to the user.

During operation, in the exemplary embodiment, because of damage within component 104, for example, component 104 may change positions with respect to probes 110 resulting in a displacement (not shown) of each probe 110 with respect to component 104. In the exemplary embodiment, each probe 110 measures the displacement of component 104 with respect to each probe 110 in order to detect damage within component 104, such as a crack within component 104 and/or a misalignment of component 104. Each probe 110 may also measure the speed of component 104. Alternatively, each probe 110 may measure any other parameter of component 104 that enables system 100 to function as described herein.

Each probe 110 transmits at least one signal representative of the data received from component 104 to diagnostic system 116. In the exemplary embodiment, each probe 110 transmits a signal representative of the displacement between each probe 110 from component 104 and/or a signal representative of a speed of component 104 to diagnostic system 116. Diagnostic system 116 analyzes and/or processes the signals.

As explained in more detail below, the signals are then transmitted to computing device 120 for further analysis and/or processing, and for presentation of an output of the data to a user. In the exemplary embodiment, computing device 120 provides an output that includes a graphical and/or a textual representation of the data. For example, in the exemplary embodiment, computing device 120 provides a graphical representation of the data such that damage within component 104 and/or a type of damage within component 104 may be identified by computing 120 and/or a user of computing device. If the damage is determined to be a crack within component 104, then computing device 120 may transmit a signal to a control system (not shown) to stop operation of machine 102. Alternatively, the user may manually stop operation of machine 102.

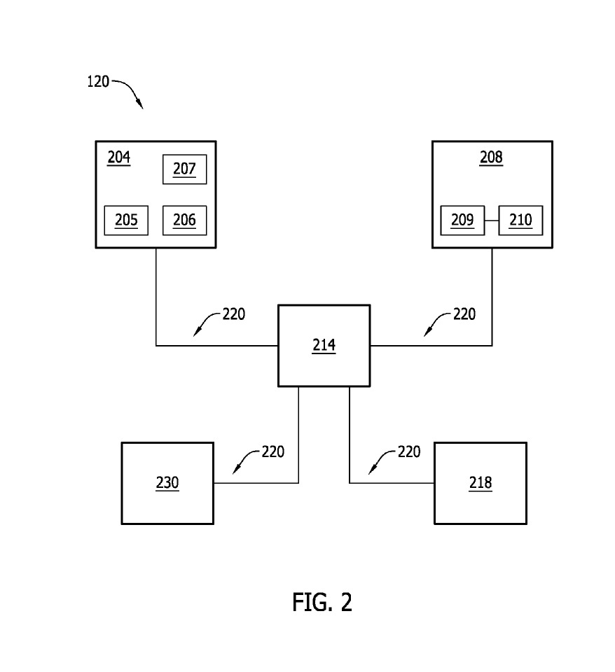

FIG. 2 is a block diagram of computing device 120. In the exemplary embodiment, computing device 120 includes a user interface 204 that receives at least one input from a user. In the exemplary embodiment, user interface 204 includes a keyboard 205 that enables the user to input pertinent information. In the exemplary embodiment, user interface 204 also includes a pointing device 206 and a mouse 207. Alternatively, user interface 204 may include, for example, a stylus, a touch sensitive panel (e.g., a touch pad or a touch screen), a gyroscope, an accelerometer, a position detector, and/or an audio input interface. (e.g., including a microphone).

Moreover, in the exemplary embodiment, computing device 120 includes a presentation interface 208 that presents information, such as input events, data output, and/or validation results, to the user. In the exemplary embodiment, presentation interface 208 includes a display adapter 209 that is coupled to at least one display device 210. More specifically, in the exemplary embodiment, display device 210 is a visual display device, such as a cathode ray tube (CRT), a liquid crystal display (LCD), an organic LED (OLED) display, and/or an “electronic ink” display. Alternatively, presentation interface 208 may include an audio output device (e.g., an audio adapter and/or a speaker) and/or a printer.

Computing device 120 also includes a processor 214 and a memory device 218. In the exemplary embodiment, processor 214 is coupled to user interface 204, presentation interface 208, and to memory device 218 via a system bus 220. In the exemplary embodiment, processor 214 communicates with the user, such as by prompting the user via presentation interface 208 and/or by receiving user inputs via user interface 204. Moreover, in the exemplary embodiment, processor 214 is programmed by encoding an operation using one or more executable instructions and providing the executable instructions in memory device 218. For example, in the exemplary embodiment, processor 214 is programmed to combine the plurality of signals received from the probe 110 (shown in FIG. 1) that is located on x observation plane 111 (shown in FIG. 1) and the probe 110 that is located on y observation plane 112 (shown in FIG. 1) to generate a plurality of displacement responses that correspond to a plurality of frequencies of a speed of machine component 104, such as, for example, 1×, 2× . . . n× of the running operational speed of component 104. Processor 214 may also be programmed to identify a first displacement response of the plurality of displacement responses that corresponds to an operational speed of the machine component 104 and programmed to identify a second displacement response of the plurality of displacement responses that corresponds to a non-operational speed of the machine component.

Processor 214 may also be programmed to transform the signals from each of the probes 110 to eliminate a plurality of split resonance effects such that the data may be graphically plotted. For example, an orbit (not shown) can be constructed from a pair of forward and reverse vectors that rotate in opposite directions at a filter frequency, w. The forward vector rotates in the same direction as component 104 (i.e., rotor) rotation. It is known that at speeds well below the resonance, the forward response may point towards a heavy spot, making it a valuable tool for balancing. The forward/reverse transform starts with a pair of vibration vectors, xᵢₙₛₜ and yᵢₙₛₜ that correspond to probe 110 that is positioned on x observation plane 111 and probe 110 that is positioned on y observation plane 112, respectively, to generate a plurality of displacement responses. The vibration vectors are first converted to the mathematical convention (positive phase lead and zero-to-peak amplitude). These vectors can be expressed in rotating form as shown in Equation (A5-5) below.

x=Ae^{j(ωt+α)}

y=Be^{j(ωt+β)} (A5-5)

In Equation (A5-5), A, B, α, and β are the amplitudes and phases of the vibration vectors in mathematical convention and α is measured relative to the X transducer axis, and β is measured relative to the Y transducer axis. Thus, the physical coordinates of the rotor centerline on the filtered orbit are (x, y), where, as shown in Equation (A5-6) below,

x=A cos(ωt+α)

y=B cos(ωt+β) (A5-6)

The transform to forward and reverse uses the identity shown in Equation (A5-7) below.

$$cos θ = \frac{{e}^{j θ} + {e}^{- j θ}}{2} \qquad ( A 5 \text{-} 7 )$$

This identity is substituted into Equation A5-6 to obtain Equation (A5-8) below.

$$x = \frac{1}{2} A [ {e}^{j ( ω t + α )} + {e}^{- j ( ω t + α )} ] \\ y = \frac{1}{2} B [ {e}^{j ( ω t + β )} + {e}^{- j ( ω t + B )} ] \qquad ( A 5 \text{-} 8 )$$

It should be noted that the exponential expressions contain terms that represent vectors that are rotating in the mathematically positive direction, e^{jwt}, which is equivalent to forward precession, and the negative direction, e^{-jwt}, which is equivalent to reverse precession. Now the second equation in (A5-8) can be multiplied by j, and the two equations can be added together, and combine forward and reverse parts to obtain Equation (A5-9) below.

x+jy=1/2[Ae^{j(ωt+α)}+jBe^{j(ωt+β)}]+1/2[Ae^{-j(ωt+α)}+jBe^{-j(ωt+β)}] (A5-9)

The sum of these four complex, rotating vectors represents the instantaneous position of a rotor centerline (not shown) in the filtered orbit. The orbit exists in what is now a complex plane (X+jY) with the real axis aligned with the X transducer. The two vectors in the left bracket rotate in the forward direction (+ω) and the two in the right bracket are reverse (−ω). Setting t=0 provides the filtered position at a reference event (i.e., the Keyphasor event) in terms Of the measured vibration vectors, as shown in Equation (A5-10) below.

(x+jy)ₜ₌₀=1/2(Ae^{jα}+jBe^{jβ})+1/2(Ae^{-jα}+jBe^{-jβ}) (A5-10)

Equations (A5-9) and (A5-10) can be used in a computer program, such as MATLAB, that supports complex numbers in this form. However, it may be necessary to find expressions for the amplitude and phase of the forward and reverse vectors. Equation (A5-9) can be described by the sum of two forward and reverse rotating vectors, as shown in Equation (A5-10) below.

x+jy=A_{F}e^{j(ωt+φ}_{^{F}}⁾+A_{R}e^{j(-ωt-φ}^{_{R}}⁾ (A5-11)

In Equation (A5-11), where A_{F} and A_{R} are the amplitudes of the forward and reverse vectors, and φ_{F} and φ_{R} are the phases, both measured relative to the X axis. The right sides of Equations (A5-9) and (A5-11) at t=0 can be compared, as shown in Equations (A5-12) below.

A_{F}e^{jφ}^{_{f}}=1/2(Ae^{jα}+jBe^{jβ})

A_{R}e^{-jφ}^{_{R}}=1/2(Ae^{-jα}+jBe^{-jβ}) (A5-12)

The exponential functions can be expanded into trigonometric functions using Euler's identity, as shown in Equation (A5-13) below.

e^{jθ}=cos θ+j sin θ (A5-13)

Applying Euler's identity to the right sides of Equations (A5-12), and, after iterations, such as some algebra and a trigonometric identity or two, the following can be obtained:

A_{F}=1/2[A²+B²+2AB sin(α−β)]^{0.5}

A_{R}=1/2[A²+B²+2AB sin(α−β)]^{0.5} (A5-14)

and

$${φ}_{F} = arc tan ( \frac{A sin α + B cos β}{A cos α - B sin β} ) \\ {φ}_{R} = arc tan ( \frac{A sin α - B cos β}{A cos α + B sin β} ) \qquad ( A 5 \text{-} 15 )$$

The phase angles may be calculated using the arctangent2 function to yield angles between ±180° (which can be reduced mod 360 if desired), and the data may be unwrapped to prevent jump discontinuities. It is important to note that these expressions are based on a mathematical convention where both of the phase angles are measured relative to the X (real) axis, which is aligned with the X transducer sensitive axis, and φ_{F} is measured in the positive (counterclockwise) direction. However, as a result of the phase angle definition in Equation (A5-8) for the reverse vector, positive φ_{R} is measured in the clockwise direction, which is the reverse of the known convention. Before plotting, the forward and reverse vectors should be converted to the instrumentation convention (the negative of the mathematical phase) to be consistent with other data plots. When plotted on a polar plot (not shown), as the phase lag of the forward response increases (the mathematical phase decreases), it will move in a direction opposite to rotation (the same as standard vibration vectors). On a Bode plot (not shown), it will move downward.

As the phase lag of the reverse response increases, it will move in the same direction as rotation on the polar plot, and, if plotted on the Bode plot together with the forward response, it will move upward. A full spectrum may also be calculated using the same algorithm.

Processor 214 may be programmed to generate data representative of a graphical output of the data received from the signals that are transmitted from diagnostic system 116 (shown in FIG. 1). The graphical output may include at least one peak (not shown). Processor 214 is also programmed to calculate a peak amplitude frequency and/or a peak amplitude value for the peak. Processor 214 may be programmed to identify a change in the peak amplitude frequency and/or a change in the peak amplitude value to identify a type of damage within component 104 (shown in FIG. 1). Processor 214 may be further programmed to calculate a phase lag value at the peak amplitude frequency and a slope of the phase lag at the peak amplitude frequency. In the exemplary embodiment, processor 214 may also be programmed to calculate a quality factor based at least in part by the slope, wherein the quality factor may also be used to identify the type of the damage.

The term “processor” refers generally to any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term “processor.”

In the exemplary embodiment, memory device 218 includes one or more devices that enable information, such as executable instructions and/or other data, to be stored and retrieved. Moreover, in the exemplary embodiment, memory device 218 includes one or more computer readable media, such as, without limitation, dynamic random access memory (DRAM), static random access memory (SRAM), a solid state disk, and/or a hard disk. In the exemplary embodiment, memory device 218 stores, without limitation, application source code, application object code, configuration data, additional input events, application states, assertion statements, validation results, and/or any other type of data. More specifically, in the exemplary embodiment, memory device 218 stores input data received by a user via user interface 204, and/or information received from other components of power system 100, such as data received from diagnostic system 116.

Computing device 120, in the exemplary embodiment, also includes a communication interface 230 that is coupled to processor 214 via system bus 220. Moreover, in the exemplary embodiment, communication interface 230 is coupled to diagnostic system 116 via data conduit 122 (shown in FIG. 1) and is configured to receive signals from diagnostic system 116.

During operation, in the exemplary embodiment, after diagnostic system 116 analyzes and/or processes the signals received from each of the probes 110 located on x observation plane 111 and on y observation plane 112, the signals are transmitted to computing device 120 for further analysis and/or processing, and for presentation of an output of the data to a user. More specifically, communication interface 230 receives the signals and transmits the data to processor 214. Processor 214 combines the plurality of signals received from the probe 110 that is located on x observation plane 111 and the probe 110 that is located on y observation plane 112 to generate a plurality of displacement responses that correspond to a plurality of frequencies of a speed of machine component 104, such as, for example, 0×, 1×, 2× . . . n× of the running operational speed of component 104. Processor 214 may identify a first displacement response of the plurality of displacement responses that corresponds to an operational speed of the machine component 104 and identify a second displacement response of the plurality of displacement responses that corresponds to a non-operational speed of the machine component.

Processor 214 may also transform the signals from each of the probes 110 to eliminate a plurality of split resonance effects such that the data may be graphically plotted. Processor 214 then generates a graphical output of the data, wherein the graphical output includes at least one peak. The graphical output of the peak may be presented to a user via display device 210 within presentation interface 208. When the graphical output of the peak is presented to the user, a standard graphical output of another machine component (not shown) without any damage may also be presented such that the graphical output may be compared with the standard graphical output and any variations may be identified.

Processor 214 also calculates a peak amplitude frequency and/or a peak amplitude value for the peak. The peak amplitude frequency, and/or the peak amplitude value may be presented to a user via display device 210 within presentation interface 208. Processor 214 further identifies a change in the peak amplitude frequency and/or a change in the peak amplitude value to identify a type of damage within component 104. For example, a crack within component 104 is identified when the peak amplitude frequency decreases. A misalignment of component 104 is identified when the peak amplitude frequency remains constant and/or the peak amplitude frequency increases. A textual and/or graphical representation of the type of damage may be presented to the user via display device 210. Alternatively, the user may also visually identify the change in the peak amplitude frequency and/or the change in the peak amplitude value from the graphical output that is presented to the user via display device 210 to identify the type of damage within component 104.

In the exemplary embodiment, processor 214 may also calculate a phase lag value at the peak amplitude frequency and a slope of the phase lag at the peak amplitude frequency. Processor 214 then calculates a quality factor based at least in part by the slope, wherein the quality factor may also be used to identify the type of the damage. For example, if the damage within component 104 is a crack, then the quality factor would have a relatively high standard deviation when compared with a quality factor resulting from the standard graphical output.

As compared to known systems and methods that are used to identify damage within machine components, the exemplary systems and methods described herein enable a user to readily identify a type of damage within a machine component, such as a crack within a rotor shaft of a turbine. More specifically, the embodiments described herein provide a computing device. The computing device includes a communication interface configured to receive a plurality of signals from a first probe positioned on a first observation plane of a machine component and a second probe that is positioned on a second observation plane of the machine component, wherein the plurality of signals are representative of data from the machine component. A processor is coupled to the communication interface and programmed to combine the signals received from the first probe and the second probe to generate a plurality of displacement responses that correspond to a plurality of frequencies of a speed of the machine component. The processor is also programmed to transform the plurality of signals received from each of the first probe and the second probe to eliminate a plurality of split resonance effects. The processor may also generate data representative of a graphical output of the data received from the signals to identify a type of at least one fault within the machine component. The processor is also programmed to calculate a peak amplitude frequency and/or a peak amplitude value for the peak. The processor is further programmed to identify a change in the peak amplitude frequency and/or a change in the peak amplitude value to identify a type of at least one fault within the machine component. For example, a decrease in the peak amplitude frequency is representative of a crack within the machine component and an increased and/or a constant peak amplitude frequency is representative of a different type of fault, such as a misalignment of the machine component. Accordingly, not only can a fault be detected within the component, but a user can readily identify whether the fault detected is a crack, such as a shaft crack, or a different type of fault.

A technical effect of the systems and methods described herein includes at least one of: (a) receiving, via a communication interface, a plurality of signals from a first probe positioned on a first observation plane of a machine component and a second probe that is positioned on a second observation plane of the machine component, wherein the plurality of signals are representative of data from the machine component; (b) combining, via a processor, a plurality of signals received from a first probe and a second probe to generate a plurality of displacement responses that correspond to a plurality of frequencies of a speed of a machine component; (c) transforming, via a processor, a plurality of signals received from each of a first probe and a second probe to eliminate a plurality of split resonance effects; and (d) generating, via a processor, data representative of a graphical output of data received from a plurality of signals to identify a type of at least one fault within a machine component.

Exemplary embodiments of the systems and methods are described above in detail. The systems and methods are not limited to the specific embodiments described herein, but rather, components of the systems and/or steps of the methods may be utilized independently and separately from other components and/or steps described herein. For example, the system may also be used in combination with other apparatus, systems, and methods, and is not limited to practice with only the system as described herein. Rather, the exemplary embodiment can be implemented and utilized in connection with many other applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computing device comprising:
a communication interface configured to receive a plurality of signals from a first probe positioned on a first observation plane of a machine component and a second probe that is positioned on a second observation plane of the machine component, wherein the plurality of signals are representative of data from the machine component; and
a processor coupled to said communication interface and programmed to:
combine the plurality of signals received from the first probe and the second probe to generate a plurality of displacement responses that correspond to a plurality of frequencies of a speed of the machine component;
transform the plurality of signals received from each of the first probe and the second probe to eliminate a plurality of split resonance effects; and
generate an output of the data received from the plurality of signals to identify a type of at least one fault within the machine component.

2. A computing device in accordance with claim 1, wherein said processor is further programmed to:
generate data representative of a graphical output of the data received from the plurality of signals;
identify at least one peak in a graphical output;
calculate at least one of a peak amplitude frequency and a peak amplitude value for the at least one peak; and
identify at least one of a change in the peak amplitude frequency and a change in the peak amplitude value to identify the type of the at least one fault within the machine component.

3. A computing device in accordance with claim 2, wherein said processor is programmed to identify a decrease in the peak amplitude frequency such that a crack within the machine component is identified.

4. A computing device in accordance with claim 2, wherein said processor is programmed to identify when at least one of the peak amplitude frequency remains constant and the peak amplitude frequency increases such that a misalignment of the machine component is identified.

5. A computing device in accordance with claim 2, wherein said processor is further programmed to calculate at least one of a phase lag value at the peak amplitude frequency and a slope of the phase lag at the peak amplitude frequency.

6. A computing device in accordance with claim 5, wherein said processor is further programmed to calculate a quality factor based at least in part by the slope, wherein the quality factor is used to identify the type of at least one fault.

7. A computing device in accordance with claim 1, wherein said processor is further programmed to:
identify a first displacement response of the plurality of displacement responses that corresponds to an operational speed of the machine component; and
identify a second displacement response of the plurality of displacement responses that corresponds to a non-operational speed of the machine component.

8. A system comprising:
at least one machine comprising a component;
a monitoring system comprising a first probe positioned on a first observation plane of said component and a second probe that is positioned on a second observation plane of said component, wherein the plurality of signals are representative of data from said component; and
a computing device coupled to said monitoring system, said computing device comprising:
a communication interface configured to receive a plurality of signals from said first probe and said second probe, wherein the plurality of signals are representative of data from said component; and;
a processor coupled to said communication interface and programmed to:
combine the plurality of signals received from said first probe and said second probe to generate a plurality of displacement responses that correspond to a plurality of frequencies of a speed of said component;
transform the plurality of signals received from each of said first probe and said second probe to eliminate a plurality of split resonance effects; and
generate an output of the data received from the plurality of signals to identify a type of at least one fault within said component.

9. A system in accordance with claim 8, wherein said processor is further programmed to:
generate data representative of a graphical output of the data received from the plurality of signals;
identify at least one peak in the graphical output;
calculate at least one of a peak amplitude frequency and a peak amplitude value for the at least one peak; and
identify at least one of a change in the peak amplitude frequency and a change in the peak amplitude value to identify the type of the at least one fault within said component.

10. A system in accordance with claim 9, wherein said processor is programmed to identify a decrease in the peak amplitude frequency such that a crack within said component is identified.

11. A system in accordance with claim 9, wherein said processor is programmed to identify when at least one of the peak amplitude frequency remains constant and the peak amplitude frequency increases such that a misalignment of said component is identified.

12. A system in accordance with claim 9, wherein said processor is further programmed to calculate at least one of a phase lag value at the peak amplitude frequency and a slope of the phase lag at the peak amplitude frequency.

13. A system in accordance with claim 12, wherein said processor is further programmed to calculate a quality factor based at least in part by the slope, wherein the quality factor is used to identify the type of at least one fault.

14. A system in accordance with claim 9, wherein said processor is further programmed to:
identify a first displacement response of the plurality of displacement responses that corresponds to an operational speed of said component; and
identify a second displacement response of the plurality of displacement responses that corresponds to a non-operational speed of said machine component.

15. A method for identifying a type of at least one fault within a machine component, said method comprising:
receiving, via a communication interface, a plurality of signals from a first probe positioned on a first observation plane of a machine component and a second probe that is positioned on a second observation plane of the machine component, wherein the plurality of signals are representative of data from the machine component;
combining, via a processor, the plurality of signals received from the first probe and the second probe to generate a plurality of displacement responses that correspond to a plurality of frequencies of a speed of the machine component;
transforming, via the processor, the plurality of signals received from each of the first probe and the second probe to eliminate a plurality of split resonance effects; and
generating, via the processor, an output of the data received from the plurality of signals to identify a type of at least one fault within the machine component.

16. A method in accordance with claim 15, further comprising:
generating, via the processor, data representative of a graphical output of the data received from the plurality of signals;
identifying, via the processor, at least one peak in the graphical output;
calculating, via the processor, at least one of a peak amplitude frequency and a peak amplitude value for the at least one peak; and
identifying, via the processor, at least one of a change in the peak amplitude frequency and a change in the peak amplitude value to identify the type of the at least one fault within the machine component.

17. A method in accordance with claim 16, wherein identifying, via the processor, at least one of a change in the peak amplitude frequency further comprises identifying, via the processor, a decrease in the peak amplitude frequency such that a crack within the machine component is identified.

18. A method in accordance with claim 16, wherein identifying, via the processor, at least one of a change in the peak amplitude frequency further comprises identifying when at least one of the peak amplitude frequency remains constant and the peak amplitude frequency increases such that a misalignment of the machine component is identified.

19. A method in accordance with claim 16, further comprising:
calculating at least one of a phase lag value at the peak amplitude frequency and a slope of the phase lag at the peak amplitude frequency; and
calculating a quality factor based at least in part by the slope, wherein the quality factor is used to identify the type of at least one fault.

20. A method in accordance with claim 15, further comprising:
identifying a first displacement response of the plurality of displacement responses that corresponds to an operational speed of the machine component; and
identifying a second displacement response of the plurality of displacement responses that corresponds to a non-operational speed of the machine component.
